(19) United States
(12) Patent Application Publication
(10) Pub. No.: US 2023/0299987 A1
(43) Pub. Date: Sep. 21, 2023

(54) A METHOD OF FORWARDING RECEIVED BROADCAST PACKETS BY A RECEIVING NODE DEVICE IN A NETWORK OF OPERATIVELY INTERCONNECTED NODE DEVICES AND A NODE DEVICE

(71) Applicant: SIGNIFY HOLDING B.V., EINDHOVEN (NL)

(72) Inventors: JUN YAO, SHANGHAI (CN); AMOLOD JIANG, SHANGHAI (CN); PENG WANG, SHANGHAI (CN); PEILING DONG, SHANGHAI (CN)

(21) Appl. No.: 18/016,498

(22) PCT Filed: Jul. 15, 2021
(86) PCT No.: PCT/EP2021/069808

§ 371 Date: Jan. 17, 2023

(30) Foreign Application Priority Data
Jul. 27, 2020 (WO) PCT/CN2020/104777
Oct. 16, 2020 (EP) 20202302.4

(51) Int. Cl. H04L 12/18; H04W 52/02; H05B 47/19

(52) U.S. Cl. CPC H04L 12/18; H04W 52/0222; H05B 47/19

(57) ABSTRACT

A method of forwarding received broadcast packets by a receiving node device in a network of operatively interconnected node devices is disclosed. The received broadcast packets is broadcasted by a transmitting node device in the network. The method is performed by each receiving node device in the network and comprises the steps of: enabling a fast broadcasting mode in response to a trigger condition; adjusting a transmission power for forwarding received broadcast packets to a reduced transmission power, and forwarding, a broadcast packet received from the transmitting node device using the reduced transmission power. The method further comprises selectively forwarding a part of broadcast packets received from the transmitting node device. The method thereby reduces a number of broadcast packets transmitted simultaneously in the network, ensuring good network performance.

### TECHNICAL FIELD

The present disclosure generally relates to the field of communication network of interconnected node devices, and, more specifically, to a method of forwarding broadcast packets received from a transmitting node device by a receiving node device in a network of operatively interconnected node devices and a node device.

### BACKGROUND

Electric or electronic devices, such as lighting devices and Internet of Things, IoT, devices, and devices supporting enhanced Machine-Type Communication, eMTC, for example, all of which comprise data communication capabilities, are frequently deployed in networks comprised of a plurality of interconnected devices.

These devices, generally called node devices or terminal devices, or router devices, depending on their roles in different networks, may comprise a communication interface, such as a network adapter or transceiver module, for communication between node devices and possibly also with remote devices, such as a backend device or backend server.

The communication interface may operate in accordance with a network protocol for exchanging data by networked devices or nodes, such as designated ZigBee™, Bluetooth™, as well as WiFi based protocols for wireless networks, and wired bus networks such as DALI™ (Digital Addressable Lighting Interface), DSI (Digital Serial Interface), DMX (Digital Multiplex), KNX (and KNX based systems), and proprietary communication technologies and protocols, for example.

The communication interface may further operate in accordance with a wireless mobile communication standard, such as designated 2G/3G/4G/5G cellular communication, and other long-range wireless communication technologies like Long Range Wide Area Network, LoRaWAN, and Narrowband IoT, NB-IoT, or proprietary communication technologies, and/or a wired data exchange communication technology, for example.

US2018139683A1 discloses a Bluetooth mesh network implementing Bluetooth low energy technique, flooding/routing technique through hop count, relay of a message based on hop count, determination of an optimal path based on hop count, etc.

US2016104347A1 relates to grant access to user devices by matching two broadcasted codes. Para. 70 and 92 of it discloses that broadcasting device 600 may be configured to broadcast within a limited range by reducing the broadcasting power of the device.

EP3128790A1 relates to enhance power savings in a wireless network by a device awakes from sleep mode based on a known repetition intervals of wireless device discovery messages of the selected device and creates a connection with the selected device to transmit information to central devices via the connections.

WO2018160343A1 discloses a method of dynamically changing a mode of advertising for at least one of a multiple of access controls, including transmitting advertisements from an access control at a nominal mode; and changing the nominal mode in response to an event. In para. 45 and 46, it is disclosed that advertisements are transmitting at a high enough power that they are within a distance from the mobile device 12 to be received and the mode of advertising is dynamically changed, i.e. the advertising rate, transmit power, etc. over time such that an overall average power consumption provides for longer battery life.

In a network comprising multiple interconnected node devices, broadcasting is used for transmitting a message to all recipient nodes in the network, simultaneously. As an example, in a ZigBee network, a broadcast packet is intended to be propagated throughout the entire network such that all nodes receive the packet. For this purpose, node devices including coordinator and router nodes will forward or retransmit a broadcast packet once receiving the same.

Fast broadcasting in a network of interconnected node devices refers to a node device sending broadcast packets at a very fast speed for a period of time, such as dozens of minutes. Fast broadcasting is well suited for scenarios such as over the air, OTA, software updates, for example.

Fast broadcasting generally involves heavy traffic in the air, which will lead to broadcasting packets colliding each other, or the so-called broadcast storm, that also interferes later broadcast packets. The packet deliver rate, PDR, as a result will decrease sharply, which is undesirable as the network performance will degrade. The issue is particularly relevant in for example a ZigBee network, in which the router nodes try to forward received broadcast packets indiscriminately, which will cause even heavier traffic and lead to degraded network performance.

Therefore, there is a genuine need for a method which allows a node device in the network to forward or retransmit received broadcast packets in such a way that network performance, especially PDR, is not adversarially affected.

### SUMMARY

In a first aspect of the present disclosure, there is presented a method of forwarding received broadcast packets by a receiving node device in a network of operatively interconnected node devices, the received broadcast packets being broadcasted by a transmitting node device in said network, the method performed by each receiving node device in the network and comprising the steps of:
enabling, by the receiving node device, a fast broadcasting mode in response to a trigger condition;
adjusting, by the receiving node device, a transmission power for forwarding received broadcast packets to a reduced transmission power, and
forwarding, by the receiving node device, a broadcast packet received from said transmitting node device using said reduced transmission power.

The present disclosure is based on the insight that the issue of degraded network performance caused by many fast broadcast packets colliding with each other in a network of interconnected node devices can be solved by limiting or reducing a transmission power used by node devices for forwarding receive broadcast packets.

To this end, a node device receiving fast broadcast packets first enters or enables a fast broadcasting mode, in response to a trigger condition. The trigger condition relates to fast broadcasting of packets by the transmitting node device.

Upon enabling the fast broadcasting mode, the node device adjust a transmission power used for retransmitting or forwarding the received packets to a reduced transmission power. That is, the node device reduces the transmission power by a certain level. Thereafter, the node device forwards or retransmits broadcast packets that it receives from the fast broadcasting node device.

The reduced transmission power allows broadcast packets forwarded by the node device to be received by a limited or reduced number of neighbouring node device of the broadcasting or transmitting node device, thereby reducing the number of packets transmitted simultaneously in a communication channel and easing collision between packets, which eventually helps to maintain a desirable packet deliver rate. A network performance of the network comprising the interconnected node device is thereby improved or at least maintained in case of fast broadcasting.

In an embodiment of the present discourse, the method further comprises the following steps, prior to forwarding by the receiving node device the broadcast packet received from the transmitting node device using the reduced transmission power:
determining, by the receiving node device, a forwarding reference, and
determining, by the receiving node device, that a sequence number of the received packet matches the forwarding reference.

In addition to retransmitting or forwarding received broadcast packets using the reduced transmission power, the above steps of the method further limits the number of packets forwarded by the node device by selectively forwarding those packets having sequence numbers that conforms to a forwarding standard or criterion. This is realised by using a forwarding reference, or refer to it as selective forwarding reference in the following text. When a sequence number of a packet matches the selective forwarding reference, the packet is forwarded, otherwise, the packet is ignored or discarded by the node device receiving the packet.

In an embodiment of the present discourse, the trigger condition comprises:
receiving a fast broadcast indication command from the transmitting node device, or
detecting that a broadcasting interval between successive received packets is smaller than a threshold interval by the receiving node device.

The node device may enable the fast broadcasting mode on its own initiative or by following a command or instruction from the transmitting node device. The method therefore allows the node devices of the network to be centrally controlled by the transmitting node device or each node device to act independently in an intelligent way.

The fast broadcast indication command may be transmitted from the transmitting node device to the receiving node device before the fast broadcasting starts. The node device is therefore well prepared for the fast broadcasting scenario and can act relatively responsively. On the other hand, each node device acting on its own initiative allows more flexibility for the node devices.

In an embodiment of the present disclosure, the reduced transmission power is received from the transmitting node device or set by the receiving node device itself.

Similar to the trigger for the fast broadcasting mode, the reduced transmission power may also be provided by the transmitting node device, in the case of central control of node devices, or by the node device itself, when the node device intelligently operates itself by detecting fast broadcasting on its own initiative. The same beneficial effect is available from both control methods.

In an embodiment of the present disclosure, the reduced transmission power is determined based on at least one of a broadcasting interval, a number of node devices in the network, and an average node distance, and stored in the transmitting node device or the receiving node device before enabling the fast broadcasting mode.

The reduced transmission power is used to limit the number of node devices which can receive the broadcast packets. It can be contemplated by those skilled in the art the reduced transmission power may be determined based on experience data and measurement data and may vary dependent on the broadcasting interval between the broadcast packets, a number of node device that the network comprise as well as distances between the node devices. Taking all the above factors into consideration allows an optimal reduced transmission power to be determined.

Moreover, the reduced transmission power may be determined before the fast broadcasting starts and the enabling of the fast broadcasting mode. This is advantageous as it facilitates quick response by the node device to the fast broadcasting scenario.

In an embodiment of the present disclosure, the reduced transmission power is determined, by the transmitting node device or the receiving node device, using the steps of:
fast broadcasting packets respectively using different transmission powers and with different broadcasting intervals;
for each combination of a transmission power and a broadcasting interval, collecting sequence numbers of broadcast packets from receiving node devices;
for each combination of a transmission power and a broadcasting interval, calculating a packet delivery rate, and
determining the reduced transmission power based on calculated packet delivery rates.

The above steps make use of measurement data to determine the reduced transmission power. By performing broadcasting using different transmission powers and at different broadcasting intervals and collecting information on packets that are actually received by the neighbouring node devices, the PDRs under different broadcasting settings may be calculated, which allows the optimal reduced transmission power to be chosen accordingly.

In an embodiment of the present disclosure, the selective forwarding reference is a random integer number selected by the receiving node device or a number derived from a forwarding degradation coefficient received from the transmitting node device.

The selective forwarding reference is used to determine the frequency of packets being forwarded by a node device. Each node device may select the selective forwarding reference by itself or derive the selective forwarding reference to be used by itself from the a forwarding degradation coefficient received from the transmitting node device.

As example of deriving the selective forwarding reference from the forwarding degradation coefficient received from the transmitting node device comprises using a unique identifier of a node device, such as its short address to modulo the forwarding degradation coefficient.

Both approaches help to ensure that different node devices choose to forward packets with different sequence numbers, thereby reducing the number of packets being transmitted simultaneously and allow packets with different sequence numbers to have substantially equal chance of being forwarded.

In an embodiment of the present disclosure, the selective forwarding reference is at least one of: inversely proportional to the broadcasting interval and related to an average number of neighbouring node devices of the transmitting node device.

Such a selective forwarding reference is decided taking into consideration of actual operating conditions of the fast broadcasting, this is beneficial in that the selective forwarding reference may be used in a more efficient manner in selecting packets being forwarded by each node device. As an example, when the broadcasting interval is relatively smaller, a relatively large selective forwarding reference will be used, such that the node device forwards the received broadcast packets less frequently.

In an embodiment of the present disclosure, the step of determining, by the receiving node device, that a sequence number of a received packet matches the selective forwarding reference comprises determining that the sequence number of the receive packet is an integer multiple of the selective forwarding reference.

This is an exemplary way of selecting and forwarding one of N received packets, here N is the selective forward reference. The matching involves simple mathematic calculation and comparison, which is easy to implement.

In an embodiment of the present disclosure, the receiving node device operates a network layer, and the fast broadcasting indication command is comprised in a network layer data frame or a network command data frame.

The network layer is for example a ZigBee network layer defined based on the Open System Interconnections, OSI, model that conceptualizes how communications data should be processed between systems. It can be readily implemented based on the presently available protocol concept.

In an embodiment of the present disclosure, the method further comprises the following step prior to the forwarding step:
limiting, by the receiving node device, a number of neighbouring node nodes to receive packets forwarded by the receiving node device.

This is an alternative way of reducing packets transmitted simultaneously, as fewer node devices will receive a broadcast packet forwarded by the node device, which means fewer node devices receive the same broadcast packet, in comparison to not limiting the number of neighbouring node devices to receive packets forwarded by the receiving node device.

In an embodiment of the present disclosure, the method further comprises the steps of:
disabling, by the receiving node device, the fast broadcasting mode, upon receiving a fast broadcast end command from the transmitting node device, or when the receiving node device decides that the broadcast interval between successive packets is larger than the threshold interval for a predefined period, and
restoring the transmission power.

Upon completion of the fast neighbouring, the node device may resume its normal operation status by disabling the fast broadcasting mode and restoring the normal transmission power.

A second aspect of the present disclosure provides a node device for forwarding a received packet in a network of operatively interconnected node devices based on the method according to the first aspect of the present disclosure.

The node device is specifically a lighting fixture or a lighting device. The lighting fixture can operate according to the method of the first aspect of the present disclosure and keeps good network performance especially in terms of packet deliver rate during fast broadcasting.

In a third aspect of the present disclosure, a computer program product is provided, comprising a computer readable storage medium storing instructions which, when executed on at least one processor, cause the at least one processor to carry out the method according to the first aspect of the present disclosure.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 schematically illustrates a diagram of a network comprising a plurality of operatively interconnected node devices.

FIG. 2 schematically illustrates, in a flow chart type diagram, exemplary steps of a method of selectively forwarding received broadcast packets by a receiving node device in a network of interconnected node devices in accordance with an embodiment of the present disclosure.

FIG. 3 schematically illustrates, in a flow chart type diagram, exemplary steps of a method of determining a reduced transmitted power in accordance with an embodiment of the present disclosure.

FIG. 4 schematically illustrates an exemplary data frame format used by the broadcast sender for transmitting a fast broadcasting indication command including a transmission power setting and a broadcast forward degradation coefficient to a receiving node device.

FIG. 5 illustrates, schematically illustrates another exemplary data frame format used by the broadcast sender for transmitting the fast broadcasting indication command including a transmission power setting and a broadcast forward degradation coefficient to a receiving node device.

FIG. 6 illustrates, schematically, an embodiment of a node device arranged for forwarding received broadcast packets in accordance with the present disclosure.

### DETAILED DESCRIPTION

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

The present disclosure is detailed below with reference to a network of a plurality of lighting devices functioning as node devices of the network and operating according to the ZigBee protocol. Those skilled in the art will appreciate that the present disclosure is not limited to a network of lighting devices, but is applicable for networks of a wide variety of node devices enabled with network communication connectivity, as indicated in the background part.

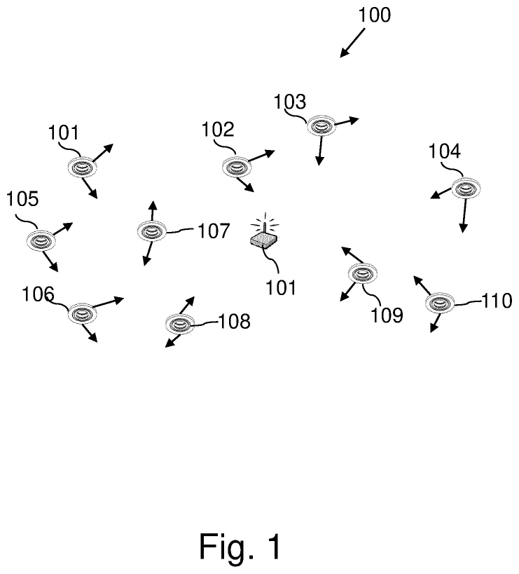

FIG. 1 schematically illustrates a diagram of a network 100 comprising a plurality of operatively interconnected node devices 101-110, in particular lighting devices operating according to one or more of IoT protocols such as the ZigBee protocol.

Network density is determined based on a number of node devices that a given node can hear, depending on transmit power of other node devices, and an ability of the given node to hear or receive transmissions from other node devices as a receiving node. The network 100, which may be an indoor ZigBee controlled lighting network having hundreds of light devices interconnected with each other, with each node device hearing many other node devices, may be considered as a middle or dense network.

The network 100 is formed and each node device commissioned based on known arts. In the example as illustrated in FIG. 1, a node device designated as 101 may operate as a so-called coordinator device, while other node devices 102-110 may operate as so called router devices.

Fast broadcasting may be use to perform software update or transmitting other information, such as collective control commands, that all node devices including the coordinator device 101 and other node device are supposed to receive. During fast broadcasting, broadcast packets are sent out at a very fast speed for a while, such as dozens of minutes. Generally, fast broadcasting may be defined based on various network sizes. As an example, for a network of 200 or more node devices, if a broadcast interval between successive broadcast packets is less than one second, a fast broadcasting is present.

Each node, including the coordinator 101, upon receiving broadcast packets transmitted by another node device such as the coordinator device 101, operates to rebroadcast or forward the received packet with a normal transmission power and rebroadcasting frequency. Due to the large number of packets transmitted at the same time in a communication channel, many packets will experience serious packet collision, which will lead to degradation of the Packet Deliver Rate, PDR.

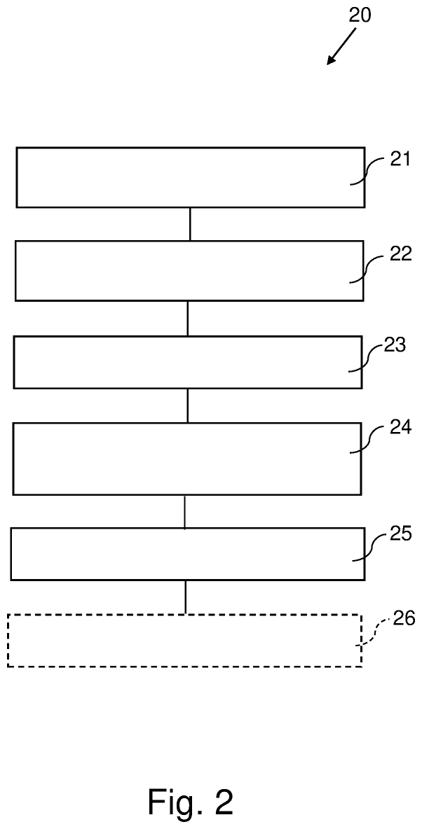

FIG. 2 schematically illustrates, in a flow chart type diagram, exemplary steps of a method 20 of selectively forwarding received broadcast packets by a receiving node device in a network of interconnected node devices in accordance with an embodiment of the present disclosure.

The method 20 is performed by each node device in the network that receives fast broadcast packets and operates to forward the received packets upon receiving the same.

At step 21 “enabling fast broadcasting mode”, a node device enables or enters a so-called fast broadcasting mode. The fast broadcasting mode may be enabled by the receiving node device on its own initiative or upon receiving an instruction or command from a node device transmitting the fast broadcast packets.

In an example referred to as centralized fast broadcasting control, a broadcast sending node or broadcast sender sends out a fast fasting command as well as other parameters to be used by node devices for determining their transmission powers and selective forwarding references to all node devices in the network.

Specifically, before starting the fast broadcasting, the broadcast sender, which may be a coordinator or a router node device, first sends out a fast broadcasting indication command to all other node devices. The fast broadcasting indication command may comprise a fast broadcasting indication as well as a transmission power setting and a broadcast forwarding degradation coefficient.

The transmission power setting is used by the receiving node device to adjust its transmission power. The determination or selection of the transmission power will be described in detail below. The broadcast forwarding degradation coefficient is used by the receiving node device to determine a forwarding frequency of the broadcast packets.

In another example referred to as intelligent fast broadcasting control, the receiving node device decides to enter the fast broadcasting mode on its own initiative and chooses the transmission power and the broadcast forwarding degradation coefficient by itself. Therefore, in this case there is no explicit fast broadcasting indication command from the broadcast sender.

The receiving node device, being it a coordinator or a router node, may detect sequence numbers of broadcast packets that it receives and calculate time intervals between successive broadcast packets, which may be referred to as broadcasting interval.

In addition, the receiving node device may detect Average Received Signal Strength Indicator, A-RSSI of the received packets. A relatively high A-RSSI level shows that the packets are transmitted using a relatively high density. A-RSSI may be calculated using (Sum of RSSI of each packets in one minute)/60, for example.

If the receiving node device determines that the broadcasting interval is less than a preset value, such as less than one second for a network with 200 node devices, and the A-RSSI detected keeps high, the receiving node device may decide that fast broadcasting is happening and choose to enter the fast broadcasting mode or state. Or else, it will not enter the fast broadcasting mode.

At step 22, “adjusting Tx power to a reduced Tx power”, the receiving node device adjusts the transmission power used for retransmitting or forwarding (received) packets to a reduced transmission power.

The reduced transmission power may be determined by the broadcast sender or the receiving node device based on experience data or measurement data or the combination of the two.

With the centralized fast broadcasting control, the setting for the reduced transmission power is received from the broadcast sender as discussed above. Methods for determining the reduced transmission power as well as detailed method of transmitting the reduced transmission power from the broadcast sender to the receiving node device will be described in detail in the following.

On the other hand, in the case of intelligent fast broadcasting control, the receiving node device, upon entering the fast broadcasting mode, will reduce the transmission power by a certain level autonomously.

The receiving node device may, in addition to reducing the transmission power, also limit a number of neighbouring node devices that can listen to messages that it transmits. As an example, the receiving node device may reduce its neighbouring nodes to a third or a fourth of a normal number of node devices.

This is specifically implemented by using different numbers of the neighbour nodes to label different transmission power levels. By considering a number of neighbour node devices, the receiving node device can control to reduce the transmission power to some extent. Different levels of Tx power, for different number of neighbour node, can be set in advance to match different fast broadcasting intervals.

The reduced transmission power is decided based on criteria that only a limited number of neighbouring node device will receive the rebroadcasting packets forwarded by the receiving node device. It can thereby reduce the number of packets being transmitted simultaneously in the network, thus preventing degradation of the network performance.

The reduced transmission power may be determined in advance and stored in a storage device in the broadcast sender or the receiving node device and transmitted to or retrieved by the receiving node device when its fast broadcasting mode is enabled.

At step 23, “Determining selective forwarding reference”, the receiving node device determines a selective forwarding reference for deciding a forwarding frequency for the received broadcast packets. That is, the receiving node chooses to forward only some of the received packets.

The selective forwarding reference is used by the receiving node device to determine whether to forward a receive packet or not. It may be derived from a broadcast forwarding degradation coefficient received from the broadcast sender or selected by the receiving node device.

The broadcast forwarding degradation coefficient is related to an average number of neighbouring nodes of the broadcast sender. The broadcast forwarding degradation coefficient is also inversely proportional to the broadcasting interval. The smaller the broadcasting interval is, the larger the broadcast forwarding degradation coefficient, which allows the receiving node device to forward receive packets less frequency, thereby limiting the number of packets transmitted simultaneously.

With the centralized fast broadcasting control, the broadcast sender transmits a broadcast forwarding degradation coefficient m. Each node device uses its unique identifier, such as, its short address to modulo the degradation coefficient to get its selective forwarding number n.

Different receiving node devices having different selective forwarding numbers further helps to reduce the packet collision and ensure packet deliver rate, as different receiving node device will forward different broadcast packets.

With the intelligent fast broadcasting control, each receiving node device selects a random number n as the broadcasting forwarding degradation coefficient. This number is in reverse ratio to the broadcasting interval. With a smaller broadcasting interval, a larger broadcasting forwarding degradation coefficient n is selected. Here the broadcasting forwarding degradation coefficient is taken as the selective forwarding number directly.

At step 24, “Determining sequence number of received packet matches selective forwarding reference”, the receiving node device decides whether to forward a broadcast packet by using a sequence number of the received broadcast packet and the selective forwarding reference determined at step 23.

In the case of centralized fast broadcasting control, when the receiving node device starts to receive fast broadcast packets, a packet sequence number is counted from one and increased with the receiving of each broadcast packet.

The packet sequence number of a received broadcast packet is made to modulo the degradation coefficient m, when a result equals to the selective forwarding number n of the receiving node device, the receiving node device will forward the broadcast packet, at step 25. Or else, it will not forward the broadcast packet as usual. In this way, the receiving node device selectively forwards one out of n broadcast packets.

With the intelligent fast broadcasting control, upon receiving a random broadcast packet, the receiving node device begins to forward the packet at step 25. Then the receiving node device will forward a broadcast packet every n packets received.

The broadcast packets are thereby selectively forwarded by the receiving node device, reducing the number of packets transmitted simultaneously.

It can be contemplated by those skilled in the art that the method 20 may further comprise a step 26 of exiting the fast broadcasting mode and restoring the normal transmission power, upon completion of the fast broadcasting. This step may be performed in response to receiving an indication from the broadcast sender indicating that the fast broadcasting has finished. Alternatively, step 26 may be performed by the receiving node device when it detects that the broadcasting interval is larger than a preset value and keeps for a while.

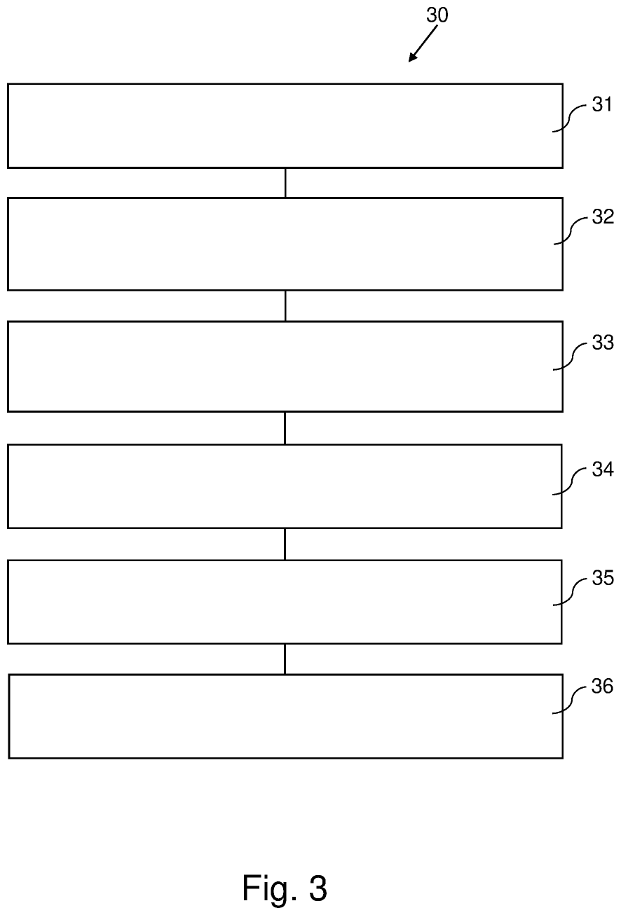

FIG. 3 schematically illustrates, in a flow chart type diagram, exemplary steps of a method 30 of determining the reduced transmitted power in accordance with an embodiment of the present disclosure.

The method 30 may be performed by the broadcast sender or the receiving node device. In the case that the reduced transmission power is determined by the broadcast sender, it is sent to the receiving node device in the fast broadcasting indication command.

It is noted that the method 30 is performed at a preparation or experiment state before the fast broadcasting starts. It aims at establishing a reduced transmission power suited for being used during the fast transmission, based on experience and/or measurement data.

At step 31, “Sending node broadcasting using a certain Tx power and with a certain broadcasting interval”, a sending node device, being it a coordinator node or a router node, transmits broadcast packets at a certain transmission power and with a specific broadcast interval.

At step 32, “Receiving node recoding broadcast packet number received”, node devices receiving the broadcast packets transmitted by the sending node record packet numbers of the broadcast packets.

At step 33, “Sending node collecting received broadcast packet numbers of each receiver”, the sending node collects the packet numbers of the broadcast packets received by the receiving nodes that receive broadcast packets from the sending node at step 31. This is done by receiving information about the received packet numbers from the receiving node devices.

At step 34, “Sending node calculating network PDR”, the sending node device calculates a network PDR based on information collected at step 33 and information on transmitted packets as well as the number of node devices in the network.

At step 35, “Sending node recording PDR for the used Tx power and broadcasting interval”, the sending node record the PDR calculated at step 34. The sending node may also record the network size and an average node distance between the node devices.

Steps 31 to 35 may be performed for multiple transmission powers and various broadcasting intervals. The transmission power and the broadcasting interval may be adjusted separately or simultaneously each time step 31 of method 30 is performed.

The PDRs obtained under multiple recorded transmission powers and broadcasting intervals can therefore provide indications as to the network performance under different transmission powers and broadcasting intervals. This allows the sending node to choose an optimal transmission power for a given broadcasting interval at step 36.

In practice, the desired Tx power during the fast broadcasting may be expressed as a function of the broadcasting interval, the network size (a number of node devices in the network), as well as distances between node devices. The following formula may be a generalized expression of the desired Tx power:

Tx power=f(interval,node number,distance),

Where interval represents the broadcasting interval, node number represents the network size, and distance shows how far a node is away from another node.

It is experimentally shown that reducing the Tx power by about 35 dBm for a dense network helps to improve PDR in the fast broadcasting the most.

The method 30 is applicable for both the centralized fast broadcasting control as well as intelligent fast broadcasting control as it can be performed by both the sending node device or the receiving node device.

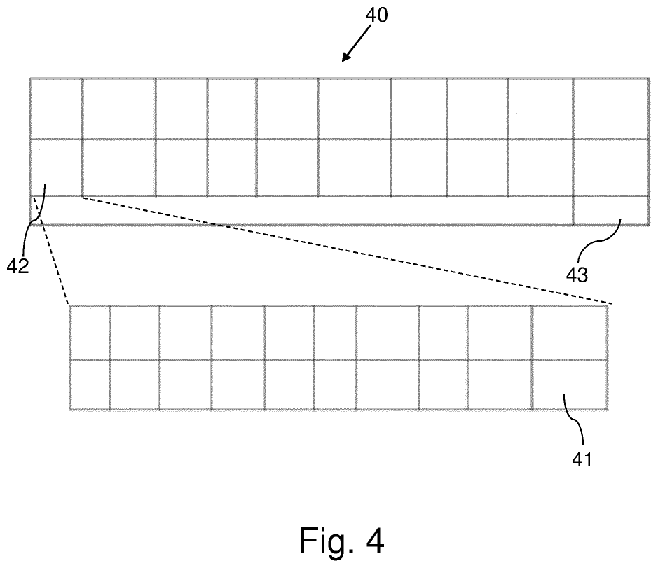

FIG. 4 schematically illustrates an exemplary data frame format used by the broadcast sender to transmit the fast broadcasting indication command including the transmission power setting and the broadcast forward degradation coefficient to the receiving node device.

As an example, a general ZigBee network layer frame format 40 is illustrated in FIG. 4. Reserved bits 14-15 indicated with a reference numeral 41 in the frame control field 42 of the network layer frame 40 may be used to convey the fast broadcasting indication command. At the same time, the payload 43 of the network layer frame 40 may be used to transmit the transmission power setting and the broadcast forwarding degradation coefficient.

The fast broadcasting indication command as illustrated in FIG. 4 is sent out as the broadcast format. Each receiving node device can identify the fast broadcasting by referring to the reserved bits 41 and then obtain the parameters, i.e., the transmission power setting and the broadcast forwarding degradation coefficient, from the network payload 43.

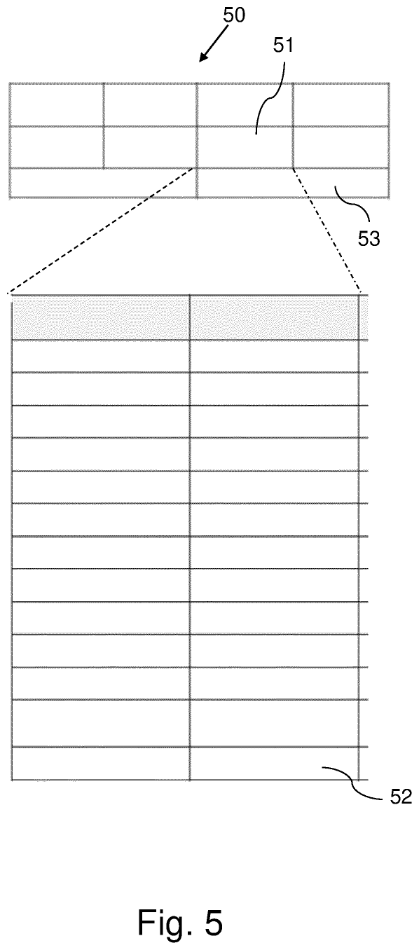

FIG. 5 schematically illustrates another example of transmitting the transmission power setting and the broadcast forward degradation coefficient to the receiving node device.

In this example, the fast broadcasting indication command is transmitted using a network command having a frame format as indicated with a reference numeral 50. The fast broadcasting indication command may be inserted into the network command identifier list 51. As an example, a new fast broadcasting start and end command may be respectively defined using reserved identifiers 52, that is, identifier number 0x0d and 0x0e.

When the node device receives the fast broadcasting start command, it can take the transmission power and broadcast forwarding degradation coefficient from the network command payload 53. Each node device receiving the fast broadcasting command can thereafter adjust the transmission power according to the data received.

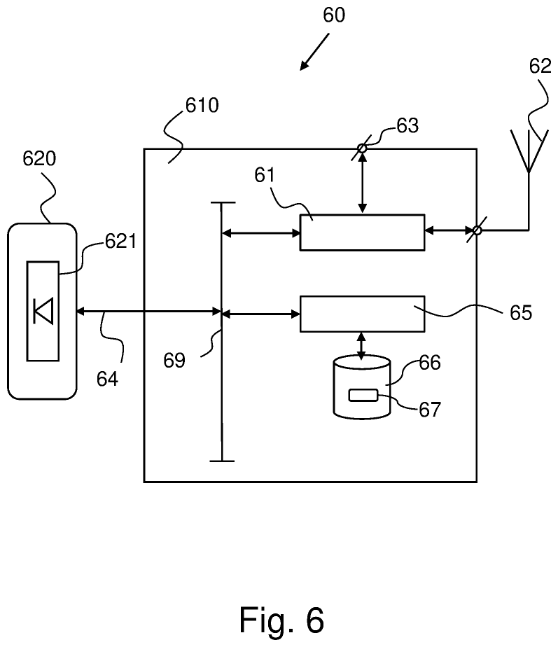

FIG. 6 illustrates, in a schematic diagram, node device 60 arranged for performing the method as described above.

The node device 60 comprises a control part or control device 610 and a load such as a lighting fixture or lighting device 620, comprising a lighting module 621, preferably a Light Emitting Diode, LED, lighting module or a plurality of LED lighting modules, operation of which may be controlled by the control device 610 from or through a remote control device, such as a remote or backend server (not shown), for example.

The control device 610 operates a communication interface 61, such as a network adapter or transceiver, Tx/Rx, module arranged for short-range wireless 62 or wired 63 exchange of messages or data packets with another node device in the network, and with the coordinator device. Network protocols for exchanging data by networked devices or nodes may comprise ZigBee™, Bluetooth™, as well as WiFi based protocols for wireless networks, and wired bus networks such as DALI™ (Digital Addressable Lighting Interface), DSI (Digital Serial Interface), DMX (Digital Multiplex), and KNX (or KNX based systems), and other proprietary protocols.

The control device 610 further comprises at least one microprocessor, μP, or controller 65, and at least one data repository or storage or memory 66, among others for storing address information 67 of the node device itself and other node devices, such as identifiers, IDs, Media Access Control, MAC, addresses. The data repository 66 may also store the optimal reduced transmission power and broadcast forwarding degradation coefficient that the node device decided by itself or received from the broadcasting sender. Instead of the data repository 66, a separate memory or storage accessible to the at least one processor or controller 65 may be provided.

The at least one microprocessor or controller 65 communicatively interacts with and controls the communication interface 61, and the at least one data repository or storage 66 via an internal data communication and control bus 69 of the control device 610. The at least one microprocessor or controller 65 may operate one or a plurality of algorithms or applications, and the protocol stack of the node device 60 comprising the network sub-layer functionality to interact with the transmitting node device and perform the method of selectively forwarding received broadcast packets.

Specifically, the at least one microprocessor or controller 65 of the node device 60 may comprise different functional modules, including an enabling/disabling module, an adjusting module, a forwarding module, a determining module, and a limiting module, for example, respectively for performing the steps of the method described above with reference to FIGS. 2 to 4.

The lighting fixture or lighting device 620 connects to and is controlled from the data communication and control bus 69 by the at least one microprocessor or controller 610 via a connection link 64.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment, system or network.

1. A method of forwarding received broadcast packets by a receiving node device in a network of operatively interconnected node devices, said received broadcast packets being broadcasted by a transmitting node device in said network, said method performed by each receiving node device in said network and comprising the steps of:
detecting that a time interval between successive received broadcast packets is smaller than a threshold interval;
enabling, by said receiving node device, a fast broadcasting mode in response to the time interval between successive received broadcast packets—being smaller than the threshold interval;
adjusting, by said receiving node device, a transmission power for forwarding received broadcast packets to a reduced transmission power in said fast broadcasting mode, and
forwarding, by said receiving node device, a broadcast packet received from said transmitting node device using said reduced transmission power.

2. The method according to claim 1, further comprising the following steps, prior to forwarding by said receiving node device said broadcast packet received from said transmitting node device using said reduced transmission power:
determining, by said receiving node device, a forwarding reference, and
determining, by said receiving node device, that a sequence number of said received packet matches said forwarding reference.

3. The method according to claim 1, wherein said trigger condition comprises:
receiving a fast broadcast indication command from said transmitting node device, or
detecting, by said receiving node device, that a broadcasting interval between successive received broadcast packets is smaller than a threshold interval.

4. The method according to claim 1, wherein said reduced transmission power is received from said transmitting node device or set by said receiving node device itself.

5. The method according to claim 1, wherein said reduced transmission power is determined based on at least one of a broadcasting interval, a number of node devices in said network, and an average node distance, and stored in said transmitting node device or said node device before enabling said fast broadcasting mode.

6. The method according to claim 1, wherein said reduced transmission power is determined, by said receiving node device, using the steps of:
broadcasting packets respectively using different transmission powers and with different time intervals between successive broadcast packets;
for each combination of a transmission power and a time interval, calculating a packet delivery rate, and
determining said reduced transmission power based on calculated packet delivery rates.

7. The method according to claim 2, wherein said forwarding reference is a random integer number selected by said receiving node device or a number derived from a forwarding degradation coefficient received from said transmitting node device.

8. The method according to claim 2, wherein said forwarding reference is at least one of: inversely proportional to said broadcasting interval and related to an average number of neighbouring node devices of said transmitting node device.

9. The method according to claim 2, wherein said step of determining, by said receiving node device, that a sequence number of a received packet matches said forwarding reference comprises determining that said sequence number of said receive packet is an integer multiple of said forwarding reference.

10. The method according to claim 3, wherein said receiving node device operates a network layer, said fast broadcasting indication command is comprised in a network layer data frame or a network command data frame.

11. The method according to claim 1, further comprising the step of, prior to said forwarding step:
limiting, by said receiving node device, a number of neighbouring node nodes to receive packets forwarded by said receiving node device.

12. The method according to claim 1, further comprising the steps of:
disabling, by said receiving node device, said fast broadcasting mode, upon receiving a fast broadcast end command from said transmitting node device, or when said receiving node device decides that said broadcast interval between successive packets is larger than said threshold interval for a predefined period, and
restoring said transmission power.

13. A node device for forwarding a received packet in a network of operatively interconnected node devices according to the method of claim 1.

14. The node device of claim 13, comprising a lighting fixture.

15. A non-transitory computer program product, comprising a computer readable storage medium storing instructions, which, when executed on at least one processor, cause said at least one processor to carry out the method according to claim 1.
